(19) United States
(12) Patent Application Publication
(10) Pub. No.: US 2009/0074265 A1
(43) Pub. Date: Mar. 19, 2009

(54) IMAGING REVIEW AND NAVIGATION WORKSTATION SYSTEM

(75) Inventors: Frank HUANG, SAN JOSE, CA (US); Gordon WILSON, SAN FRANCISCO, CA (US); Kang Huai WANG, SARATOGA, CA (US)

Correspondence Address: BROSEMER, KOLEFAS & ASSOCIATES, LLC, 1 BETHANY ROAD, BUILDING 4 - SUITE # 58, HAZLET, NJ, 07730, US

(73) Assignee: CAPSOVISION INC., SARATOGA, CA (US)

(21) Appl. No.: 11/856,098

(22) Filed: Sep. 17, 2007

(51) Int. Cl. G06K 9/00

(52) U.S. Cl. 382/128

(57) ABSTRACT

An imaging review system that displays sequences of in-vivo panoramic images stitched together into a single video while providing edit/review/location information of the individual images within the body being imaged.

### FIELD OF THE INVENTION

This invention relates generally to the field of medical imaging and in particular to a workstation-based, review and navigation system for in-vivo composite panoramic images.

### BACKGROUND OF THE INVENTION

In a number of medical applications the ability to generate a panoramic image exhibiting a substantial field of view e.g., 360° is of great utility. Efforts involving the production of such images may employ for example, endoscopes, borescopes, or swallowable capsules. Given these efforts, a corresponding development of systems that permit or facilitate the ability to derive informational value from these images would also be beneficial.

### SUMMARY OF THE INVENTION

We have developed an imaging workstation system which facilitates the review and navigation of diagnostic images and in particular panoramic images captured for example, by endoscopic, borescope, swallowable capsule or other in-vivo image capturing devices.

In a preferred embodiment the system includes a workstation having a graphical user interface via which the user interacts with the system. The layout, composition and contents of the graphical user interface permit a user to review and navigate in-vivo diagnostic images which may advantageously be presented in a panorama wherein individual overlapping panoramic images are combined. User definable markers provide relative location and distance information along with optional annotations.

The details of one or more embodiments of the invention are set forth in the accompanying drawings and the description below. Other features, objects and advantages of the invention will be apparent from the description, drawings and claims.

### BRIEF DESCRIPTION OF THE DRAWING

A more complete understanding of the present invention may be realized by reference to the accompanying drawing in which:

FIG. 1 shows a schematic of a computer workstation as employed in the present invention;

FIG. 2A shows a representative graphical user interface according to the present invention; FIG. 2B shows an alternative representative graphical user interface according to the present invention.

FIG. 3A shows a illustrative 3D model of a section of a colon while FIG. 3B shows a rendering of the colon surface in the 2-dimensional display surface, according to the present invention.

FIG. 4 shows a representative graphical user interface including the annotation window according to the present invention;

FIG. 5 shows the relationship between a constituent image and a cylindrical shape;

FIGS. 6(A), 6(B) and 6(C) show an example procedure involved in stitching together multiple images into a composite image; and

FIG. 7 shows the position estimation of an imaging capsule according to the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

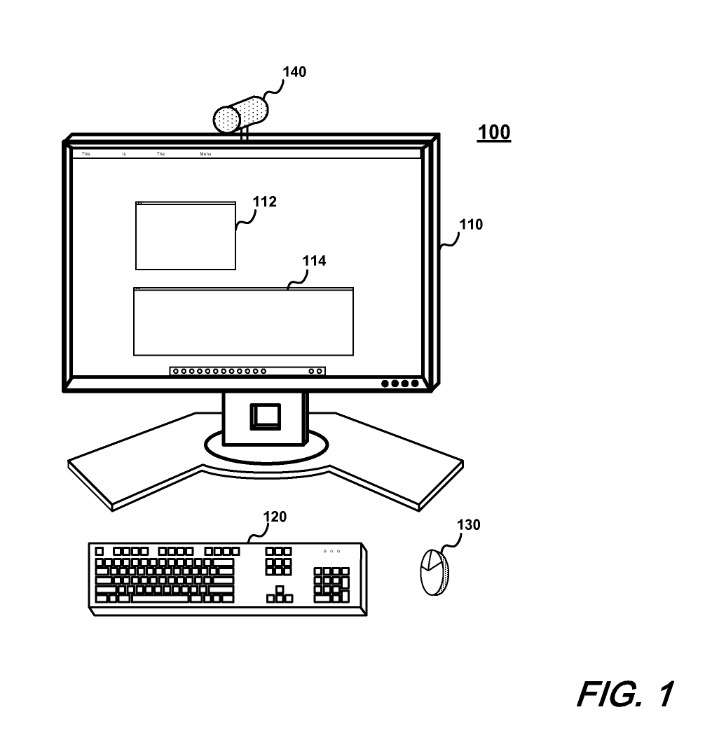

With initial reference to FIG. 1, there is shown a representative computer-based workstation system 100 for use with the present invention. As those skilled in the art will be readily familiar, such a system includes user input-output devices including high-resolution display 110 supporting a graphical user interface 112 which employs a number of “windows” 114 which advantageously may be tiled or overlapping as desired by a user. Other familiar input devices for use with the workstation system 100 include a keyboard 120 and a mouse 130 or trackball. When appropriately supported, user input may also include spoken commands input via microphone 140.

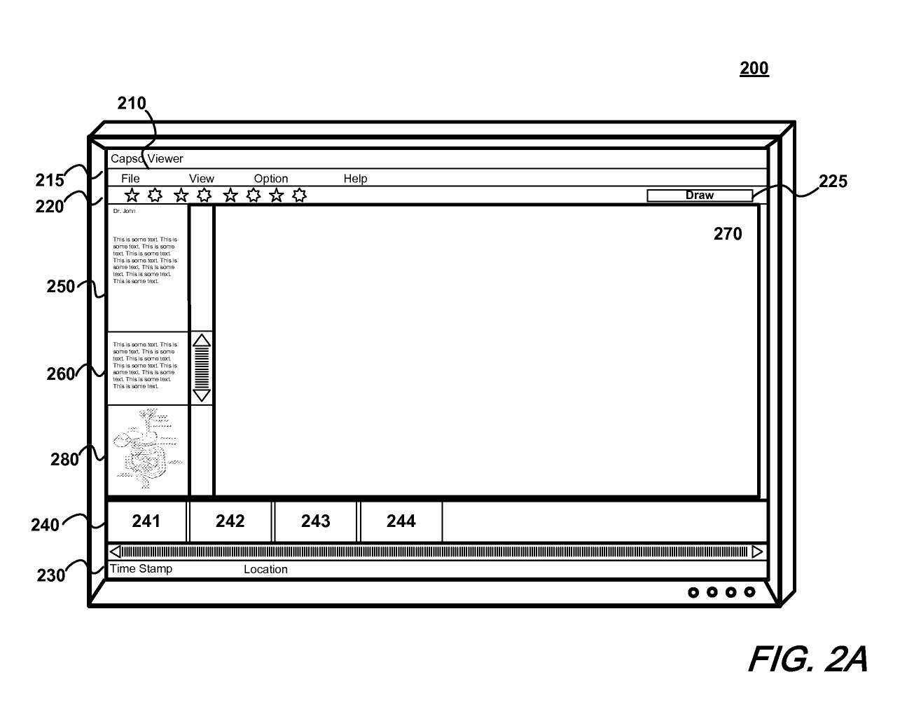

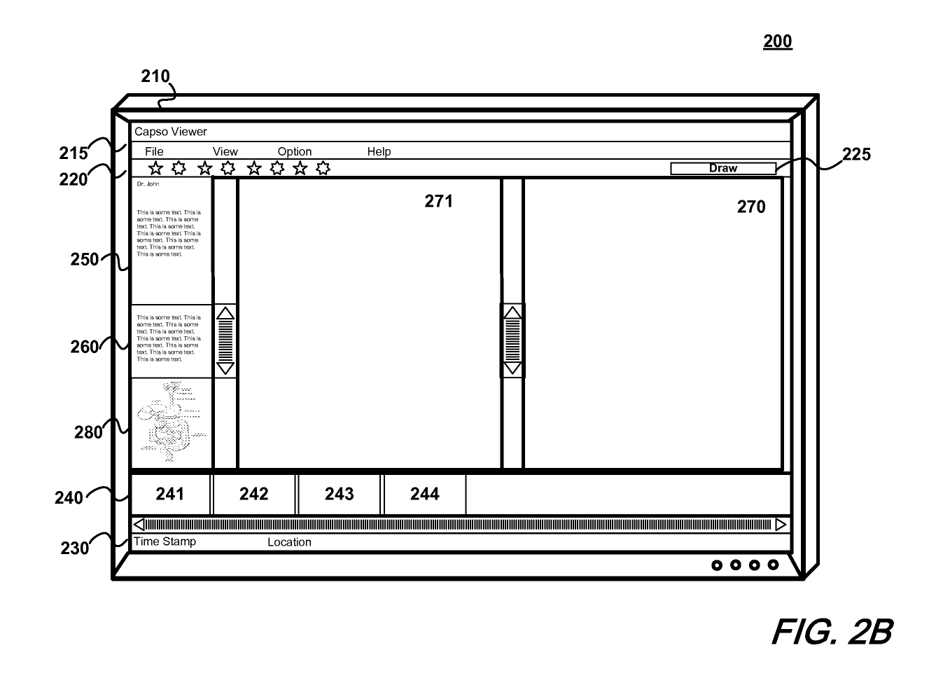

Referring now to FIG. 2, a representative graphical user interface 200 according to the present invention is shown. In particular, application main screen window 210 includes a number of elements, namely a menu bar 215, a tool bar 220 and a set of drawing tools 225 which are placed at the topmost portion of the window 210, while a status bar 230 is positioned at the bottom. Note that the placement of these elements is consistent with what one would find in a number of graphical user interfaces, thereby enhancing the familiarity of the system to a novice user. Of course, those skilled in the art will appreciate that the locations of these elements are merely exemplary and their particular location on the screen or relative to one another may be varied to facilitate a user experience.

The menu bar 215 presents a number of menu items to a user of the system namely: File, View, Option and Help. The menu bar is usually anchored to the top of the window under its title bar. Those skilled in the art will readily appreciate that these functions may be accessible via any of a variety of the input devices described previously, i.e., mouse, track ball, keyboard (shortcuts), and voice response where additional voice response software is employed.

The tool bar 220 is shown as a row of onscreen buttons or icons that, when clicked, activate certain functions of the program. As shown in this exemplary main screen window 210, the tool bar buttons may be used for functions such as:
1. Image Load—Capture image files associated with a particular patient diagnosis.
2. Open Existing File—Open existing patient data file to review, print, report.
3. Save File—Save diagnosis results to disk.
4. Create CD—Save the patient diagnosis data to a CD for distribution and future reference.
5. Print Report—Print the current opened diagnosis data.
6. Cut, Copy, Paste and Delete—Standard editing functions.
7. Property—Open a property page and enter patients
8. Zoom In/Out—Scales Up/Down an image currently shown in image window.
9. Whole, Cropped, Video and Summary—Sets display mode of Image window.
10. Increase/Decrease luminance of image.
11. Adjust gamma correction.
12. Measurement tool.
13. Screen.
14. Adjust view angle/position

The remainder of the tools shown in the tool bar are part of a graphic tool bar 220 which may, for example, be dedicated to graphical functions which include a select tool, an annotation tool, a highlighter tool, etc. In a preferred embodiment, only one of the graphical tools is activated at a time.

In a preferred embodiment, a “current working status” of the system includes both a “current” location and a time as indicated by the system, which correspond to a location, within a body, shown in an indicated (selected) image region, and the time, recorded as a “time stamp”, at which the indicated image region was captured by the in vivo imager. Because the imager may have imaged the current location multiple times, possibly moving forward and then backward to the same location, the current time should, in general, constitute a plurality of time stamps or a range of time.

As can be readily appreciated by those skilled in the art, an image region may be “indicated” in a number of ways. More particularly, it may be situated in the center of a displayed image within the frame of a display window. Alternatively, it may be the location of the cursor within an active image display window or the location of an icon or border placed in an active image display window.

Advantageously, and according to the principles of the present invention, when the indicated (selected) image is updated in one window, for example by panning the image within the window, moving the cursor, forming or reforming a graphical border, placing a new icon marker, moving an existing icon, or selecting a different existing marker within the window to be “active”, the current location and time may be updated by the system in any other windows as well.

For example, a stitched panoramic image covers a significant anatomical distance and various mechanisms such as markers are useful to select a region within a larger region to be “current”. For example, in a video display window a single image captured in a single exposure interval (a frame) is displayed at a given time. The total area of an organ displayed in a frame is small. Thus, the frame itself indicates the active location and time. As the video frame is updated, the display of current position and time in other windows is also update automatically. Alternatively, if the current position and time are updated in the composite panorama, for example by moving a marker, the frame in the video window will likewise update automatically.

The status bar 230 displays the current working status and data of the system. By way of example, it displays the current time stamp and position corresponding to a selected image region within an image e.g. of the colon, currently displayed in the image window 270. It also shows the total length of the colon image, current zoom value and current system mode. Advantageously, the image position may be described in relative terms, e.g. “66% of the way from ileal-cecal valve to anus”, or described in absolute terms, e.g. “14 cm from ileal-cecal valve.

The main screen window 210 includes a number of subscreen windows, each of which provides additional individual functionality. More particularly, the subscreen windows shown in this exemplary interface 200 include a property window 250, a file list window 260, an imaging capsule location window 280, an annotation window 240, and an image window 270. Advantageously, and as we shall discuss in more detail, a number of these individual subscreen windows may contain their own, localized controls.

The informational value of the main screen window will become apparent with continued reference to FIG. 2. In particular, property window 250 is used to present information relating to physician(s), test(s), and patient(s). Illustratively, the property window 250 may present the name(s) of the doctor, hospital, and patient relating to the particular image(s) currently under review. More particularly, the property window may display Test date/time; Diagnosis date/time; Patients information, i.e., name, phone, address, age, gender, DOB, general complaint; Doctor's information, i.e., name, phone; and Clinic information.

The file list window 260 lists diagnosis files currently saved to the workstation system. Advantageously, a user may easily locate files and open them. Illustratively the file list window shows a directory/file tree which is currently under review. As those skilled in the art will recognize, such a window oftentimes includes localized controls which—in the case of the file list window 260—permits a user of the system to scroll among a list of files.

The imaging capsule location window 280 shows the derived physical location of the imaging capsule within the body of the individual for whom the images are being taken that corresponds to an in vivo image shown in the image window. For example, if the images were being taken in the individual's colon, then an anatomical illustration of the colon would be displayed in the imaging capsule location window 280 along with an indication of capsule location or corresponding window image location within the colon.

Advantageously, the images taken by the imaging capsule as it progresses through the colon are displayed in an image window 270. In a preferred embodiment, the images taken are sequentially displayed in the image window 270 such that a “video” of the interior colon is displayed. As noted, the particular image(s) which comprise the video are taken at that location indicated by the capsule position relative to the colon shown in the imaging capsule location window 280. Accordingly, as the video progresses through an individual's colon, the location of the imaging capsule will appropriately move in the capsule location window 280.

Alternatively, separate, simultaneous windows having images 270 and video 271 may be displayed, for example as tiled windows next to one another as shown in FIG. 2B. As a result of the individual windows being independently flexible, movable, and sizeable, a variety of display options are available to an end user of the system as application requirements dictate.

As will be discussed, the image(s) and/or video(s) displayed within the imaging window 270 are composite, panoramic images, stitched together from a number of individual images. That composite image has a panoramic perspective and is constructed from a mosaic of overlapping constituent images. Importantly, and as can be appreciated by those skilled in the art, video images need not be panoramic—although it may be generally desirable for them to be so.

Advantageously, each constituent image may be a panorama itself (a sub panorama), or subsets of the set of all constituent images may form sub panoramas that cover a fraction of the total length of the imaged organ, such as the colon, that is displayed in the composite panorama. In the context of in vivo imaging, a panorama or sub panorama may be defined as any image or set of images that contains, substantially in its entirety, a circumference of the internal organ imaged. In video mode, preferably, each frame is a sub panorama.

As a series of images are reviewed, the user of the system may advantageously annotate selected images or portions thereof. Such images are displayed in the annotation window 240. Shown displayed in the annotation window 240 are one or more “cropped” images of those displayed in the imaging window 270, preferably as a “thumbnail”. As known by those skilled in the art, thumbnails are reduced-size images which make it easier to recognize their full-size counterpart. Thumbnails serve a similar role for images as a text-based index does for words. Of particular importance to the present invention, each of the thumbnails includes a time stamp and distance. The time stamp is the time of the image represented by the thumbnail, while the distance is indicative of where, for example, in the colon the image was taken. Additionally, it is advantageous that physicians or other viewers of images displayed on the workstation may write annotations as needed, even adding to annotations provided earlier by other users.

The image displayed is constructed from a number of smaller images and is generally known as a “snake-skin” image—meaning that it is long in width and narrow in height and that it is the mapping of a tubular surface onto a plane. When displayed in the imaging window 270 it may be scrolled or panned horizontally using the horizontal scroll bar. Panning vertically may be performed by using a mouse and up arrow/down arrow icons. As can be appreciated, the panoramic image displayed in the imaging window is a full 360 degree view so that when panned across the panoramic field of view, it scrolls continuously, wrapping around the frame of the window. As a result, when panned through suspicious areas, the image will display any suspicious areas continuously—and not broken as with other systems.

Those skilled in the art will readily recognize that when such “wrap-around” views of an image are employed, portions of the image which are scrolled or otherwise moved out of the window on a given side of the window “wrap-around” or otherwise get displayed at the other, opposite side of that window. In this manner, portions of an image which are scrolled off-widow over the top border, for example, will “wrap-around” and re-appear from the bottom of that window.

While such a wrap-around is quite advantageous when viewing a panoramic image such as those resulting from an in-vivo imager, it can be appreciated that the likelihood of overlooking regions of diagnostic interest is minimized if all regions can be viewed continuously without a break. Accordingly, and advantageously according to another aspect of the invention—a redundant overlap area may be displayed at the edges of the window where the wrap-around takes place. More particularly, these overlap areas advantageously maintain and display an overlap region of the image where image portions that are being wrapped will appear in the opposite overlap area before they disappear from the initial overlap area. In this manner, image portions that are about to be scrolled off-screen will appear in the opposite overlap area before they disappear as a result of the scrolling. In this manner, the context, i.e., surrounding area of an image will be preserved as that image is wrapped. As a result, the overlap areas will contain and display some redundant image information relative to one another.

A 3D spatial model of the colon may also be derived from multiple overlapping constituent images. The spatial model is derived as a self-consistent model of the colon, the capsule within it, and the lighting. Information about the lighting conditions for each image may be gathered by the capsule, stored in memory, and used in the creation of the virtual reality. A rendering of this spatial model may be displayed in the imaging window 270. This rendering may be viewed and manipulated by the user as a virtual reality with controllable view point, view angle, zoom, and lighting.

The model may lack information about regions of the colon surface that are folded or otherwise obscured and consequently were not imaged by the in vivo imager. These gaps in the model will not affect the rendered image as long as the perspective used to display the image does not deviate dramatically from the perspective from which constituent images were captured.

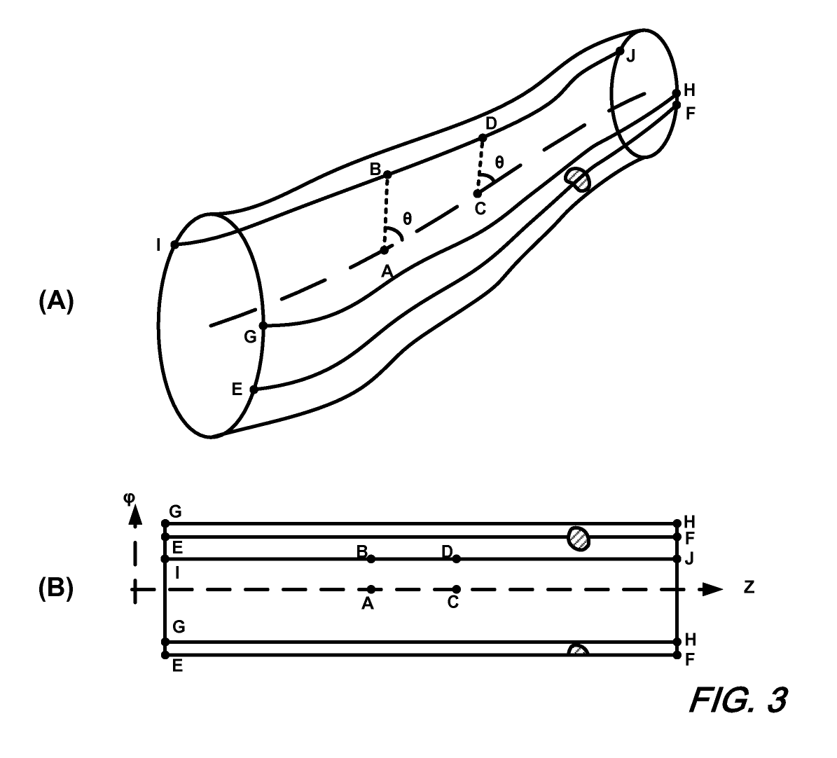

FIG. 3A illustrates the 3D model of a section of the colon. FIG. 3B illustrates a rendering of the colon surface in the 2-dimensional display surface. Each point on the model corresponds to an object point captured in one or more photographs and subsequently maps to a point on the rendered composite display image FIG. 3B. The rendered composite image may be displayed with a perspective that is orthographic along a longitudinal curve within the colon model but panoramic about that curve. On the display, the longitudinal curve may be presented as a straight line axis z. The azimuthal axis φ is represented as an axis perpendicular to the z axis. In a preferred embodiment, the resulting display is rectangular in shape (FIG. 3B). Lines of projection from centers of perspective A and C along the longitudinal curve to object points B and D on organ meridian IJ each form an angle θ with the longitudinal curve. Similarly, each object point along IJ has a corresponding center of perspective on the longitudinal curve. The centers of perspective are used to produce the rendering and need not correspond to any of the centers of perspective from which constituent images were captured.

In one form of panoramic image, the angle θ would equal 90° for all meridians (i.e. for all angles φ). However, in a modified panoramic image, θ may not equal 90°. In one version, θ is constant for all angles φ such that the lines of projection from a center of perspective form a cone. In another version, the lines of projection might lie in a plane so that θ is a function of φ.

By adjusting θ, the user shifts the view angle from one “looking from the left” to one “looking from the right”, thereby allowing the user both a sense of the 3 dimensional surface topology and a view of regions that might be partially obscured or overly foreshortened from a single view point. A selectable feature causes the view angle to oscillate automatically.

An important aspect of a diagnosis may be measuring the physical size of features such as polyps within the colon or other organ. Each point in the image corresponds to a different object distance and hence to a different magnification. Also, the surface does not form a consistent angle with lines of projection. Thus, a single scale cannot be used to measure lengths, such as polyp diameters, on the display image. However, the graphical user interface may include a measurement tool. Two points on the image may be selected and the distance between the corresponding object points within the colon calculated directly from the 3D spatial model.

An additional window may render the spatial model from a single point of view. The perspective would be that of a tiny submarine within the colon. The point of view could be manipulated and indicated using an icon or cursor in the composite image window. Other controls such as a joy stick or arrow keys could also manipulate the center of perspective, the view angle, the field of view, and zoom. The location and orientation of the icon could be updated with these controls at the same time.

The display image may be intentionally distorted in various ways. For example, it could be distorted to make the magnification of the lumen wall in the image as uniform as possible. With such a distortion, the image is not, in general, rectangular. Its width in the φ direction may vary along the z direction in proportion to the circumference of the colon. Furthermore, the longitudinal axis may map to a differently shaped curve, not necessarily a straight line. A curved shape, for example, would allow a greater length of colon to occupy the screen at one time.

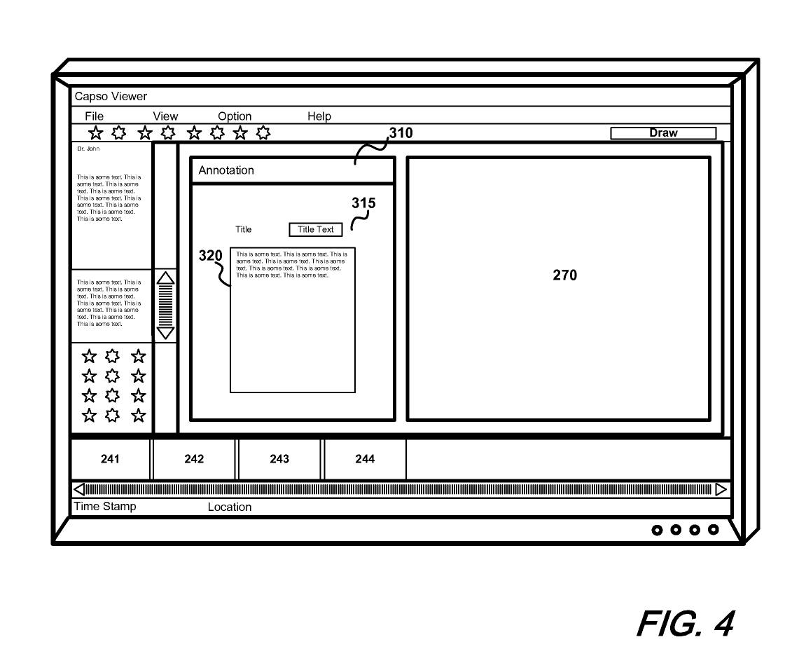

It was previously noted that according to the present invention, diagnostic or other annotations may be added to an image portion. In order to add such an annotation, a user makes a cropped image (i.e., colon segment image) from the entire image displayed in the imaging window 270. With reference now to FIG. 4, there is shown a representative screen from the imaging workstation during a crop/annotate process. Advantageously, cropping is intuitive and a “marker” icon is chosen from the graphic toolbar and dragged over a portion of the image to be cropped by selecting the mouse button. As a result, an annotation dialog 310 is displayed in which any annotation text 320 and title information 315 is entered. Upon completion of the annotation, the annotation window is closed and a marker with that number is added to the bottom of the image screen. In addition, a new thumbnail image is added into the annotation window, where the title text is overlapped on that image.

Operationally, if a user of the imaging review system wishes to review an annotation and/or a larger or higher-resolution version of a thumbnail, the thumbnail may be “dragged” from the annotation window to the image screen or alternatively a marker icon may be clicked (double clicked).

As noted, the image displayed in the image window 270 is stitched together from a number of images. Advantageously, a user may open the image window 270 to more closely inspect a particular section of the imaged object, i.e., colon. In this video mode, a video plays a sequence of still images in an order determined by their respective time stamps. In a preferred embodiment, the still images are each panoramic images. In a preferred embodiment, the composite snake-skin image may be shown side-by-side with the image window 270 in video mode. The user may also use two vertical lines on the composite image to define the section of the corresponding video to be played. In this manner, the user defines the “range” of the video to be played, i.e., the beginning and the end which correspond to the first vertical line and the second vertical line, respectively. Of course a user may pause the video at any time and drag the current video frame to the annotation container if this frame is one requiring further review. As noted previously, a time stamp and location information tag will be included in the annotated video frame(s) to assist with the selection and playback.

Advantageously, a user may select a video mode from the toolbar and utilize familiar player controls such as “forward”, “pause”, “fast forward”, “play”, “stop”, “rewind” and “fast rewind”. The functions performed by these controls are self-explanatory. Pressing the “play” button starts to play the image frames until the “stop” button is pressed.

Diagnostic summaries may be added by users by selecting the Summary icon from the tool bar. When selected, the image window shows a text box for summary information. In addition, the summary may contain all previous annotations, if any.

One particularly useful aspect of the present invention is the updating of any location icons with respect to images displayed within the imaging window 270 in location window 280. In particular, and noted previously, the imaging system which is the subject of the present invention provides display and review functions for panoramic images captured in vivo, for example by a capsule swallowed and subsequently transported throughout the internal gut. Conversely, one may click any portion of window 280 and window 270 will display the corresponding composite image.

From the images captured by that capsule as it traverses the gut a video is constructed by the imaging display system which may then be displayed/reviewed by a user of the system. In a preferred embodiment, the images displayed in the video are themselves panoramic images; these panoramic video frames may be constructed from one or more overlapping images. Concomitant with the video display, the current region within the snakeskin image, that portion of the composite image that was constructed using component images displayed concurrently in the video window, is updated. As stated before, the current location may be indicated by a marker which moves along the composite image as the video progresses. The composite image may also automatically pan to keep the current location centered in the window.

In addition, the capsule position within the gut is displayed in the capsule location window which shows the location of the capsule within the gut that corresponds to the panoramic image currently displayed in the imaging window. Accordingly, as the video progresses, the capsule location within the capsule location window is updated accordingly. Along with that update, the time of the image collection and distance traveled by the capsule is displayed as well. Of particular advantage—and according to an aspect of the present invention—the displayed distance may provide to a user the distance from the start of the image collection, or from an anatomical landmark, e.g., the beginning of the colon, to a location corresponding to a particular panoramic image. As a result, if an area of interest is identified in a portion of the video, a user of the system will know the distance of that area from the anatomical landmark.

As noted previously, the imaging review and navigation system which is the subject of the instant application employs individual images collected by an in vivo imaging system and then generates a composite panoramic image from those individual images. Generally, a composite image with panoramic perspective may be described as a mosaic of overlapping constituent image projections, which themselves may or may not be panoramic. In a preferred embodiment of the instant invention, the individual images are panoramic.

With initial reference to FIG. 5, there it is shown a relationship between contributions of each constituent image comprising a scene and the surface of a tube. Each of the constituent images captured by a capsule camera is a distorted image of a projection of each point in the scene captured by a constituent image onto the tubular surface, where lines of projection are toward a center of perspective associated with the constituent image. The center of perspective for each constituent image is within the tubular surface. In preferred embodiments, the sum of all projections completely covers the tubular surface.

With continued reference to that FIG. 5, shown are four points (A, B, C, D) of a constituent scene from which a constituent image is formed and corresponding points of its projection onto a tubular surface (A′,B′,C′, D′). As shown in FIG. 5, point O is at the center of perspective.

Such centers of perspective lie within the input pupils of one or more cameras. An in vivo imager such as a capsule endoscope may have a plurality of cameras, each with its own center of perspective, that capture a set of constituent images simultaneously. If the corresponding projections include a continuous ring around the tube, then this set forms a panorama and may be combined with other panoramas to form a composite panoramic image. Alternatively, an in vivo imager may only have a single panoramic camera, or it may have a single wide-angle camera capable of capturing circumferential images of the colon.

Whether or not a capsule imager employs one or multiple cameras, as it travels through an internal organ, it captures a series of constituent images that are used to subsequently construct a composite panorama. A composite panorama may be formed by stitching together overlapping panoramas. Alternatively, when a single camera is employed, it may rotate within the capsule on its longitudinal axis as the capsule travels parallel to that axis while capturing a set of constituent images whose projections onto the tube cover the tube forming the panoramic image.

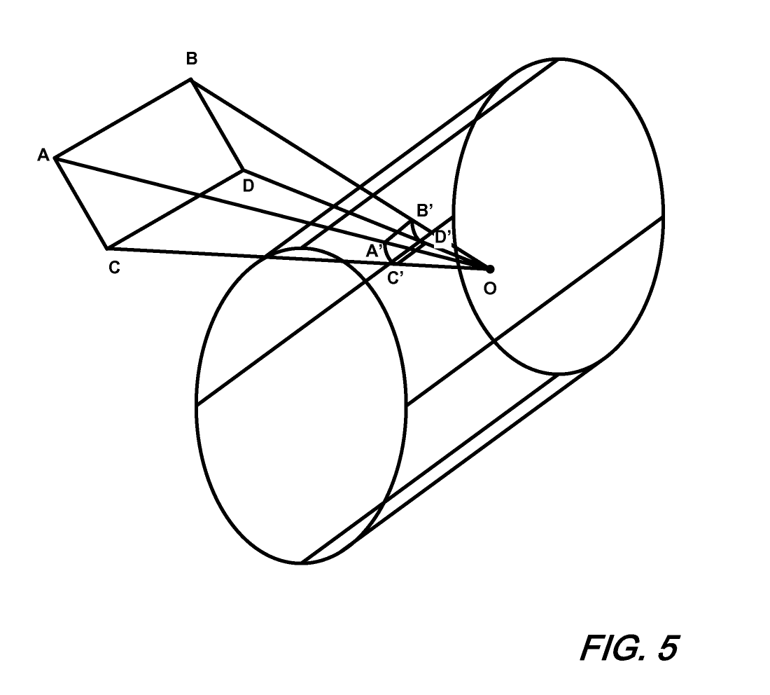

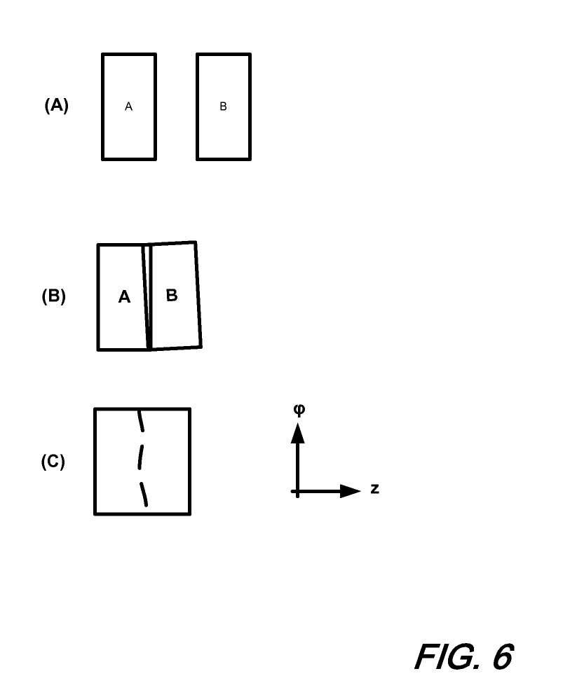

As can be appreciated by those skilled in the art, a number of known algorithms exist for image stitching. With reference to FIG. 6, there is shown a representative schematic of image stitching. By way of the example depicted in FIG. 6, if one considers two panoramic images A and B shown in FIG. 5(A), where the vertical φ direction corresponds to 360 degrees of azimuth. For reference, the horizontal direction is parallel to the capsule longitudinal axis and roughly to the predominant direction of capsule travel.

Accordingly, images A and B shown in FIG. 6(A) may include a variety of image post processing including distortion and gamma correction. In FIG. 6(B) the two images A and B are oriented and overlapped to produce a combined image having maximum cross correlation in the overlap region. The orientation includes scrolling (with wrap around) one of the images in the φ direction to account for capsule rotation between images.

In FIG. 6(C), the constituent images have been distorted in order to increase the cross correlation in the overlap region and to fit within a common rectangular shape. Additionally, the images have been combined in the overlap region using any of a number of possible algorithms, including just selecting the pixel values from one image and discarding those from the other at each point in the overlap region. Finally, the demarcation line may be obscured by techniques such as feathering to blend the two images along their overlaps. Subsequent images are stitched onto the right side of the combined AB image shown in FIG. 6(C) in a similar manner.

A display image (such as that shown in the imaging window) is formed by “cutting” a panoramic image along a curve that extends from one end of the composite panoramic image to the other. The cut image surface is mapped onto a rectangle such that the cut edges map onto two opposing sides of the rectangle (top and bottom). More sophisticated image combining algorithms use overlapping images to construct a self-consistent model of the scene, the lighting, and the camera, including pose parameters.

Whatever algorithm is used, the processing required is undertaken on the computer workstation. Within an organ such as an intestine the in vivo imager proceeds along with limited retrograde motion. Thus, image processing can proceed as follows. A first set of images is retrieved from the capsule or other storage device and loaded into workstation memory. These images are then processed to produce a composite image depicting a first section of the intestine. This image may then be displayed on screen. While the initial computation is proceeding, the image upload process continues with images uploaded in the order of their in-vivo capture. Newly uploaded images are combined with the existing composite image, and with each other, to extend the composite image. The displayed image may be updated as the composite image is generated. Thus, the clinician can view the composite image as it is constructed—saving valuable time that might otherwise be spent waiting impatiently.

A position of an imaging capsule along the intestine where a constituent image is captured may be estimated from the image's position within the stitched component image and estimations of the image magnification along a curve across the image. The position may be estimated even if a self-consistent magnification cannot be calculated everywhere.

For example, if we define a curve s that is the shortest curve that passes down the “center” of the intestine (or other internal structure being imaged) then the position along the intestine at a point x is defined by:

$$g ( x ) = {\int }_{0}^{x} d s$$

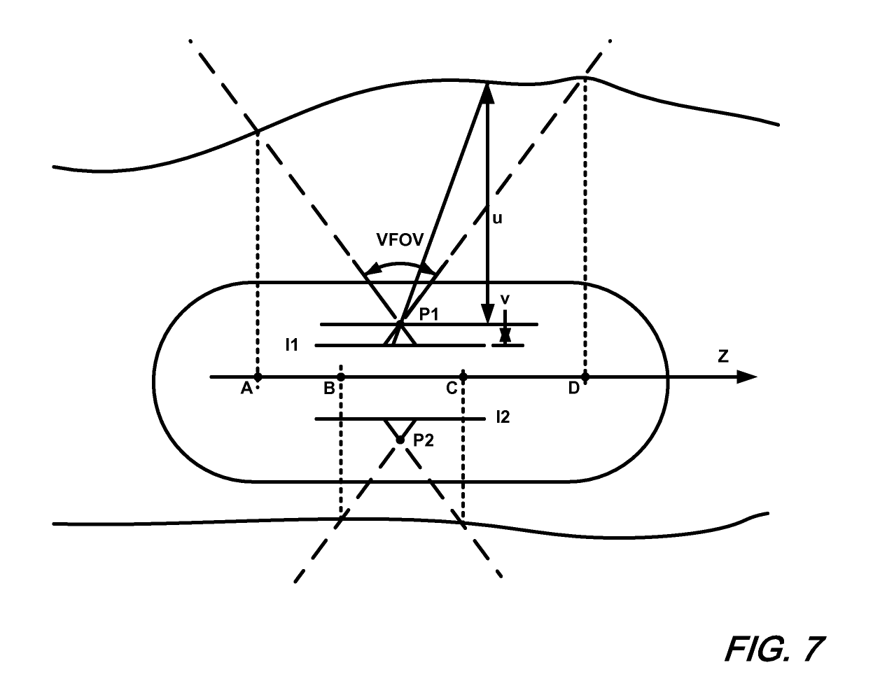

Turning now to FIG. 7, there is shown a schematic of an imaging capsule within the intestine. Two nominally identical imaging cameras with centers of perspective P1 and P2 and image planes I1 and I2 face in different directions. Both cameras have the same vertical field of view (VFOV). On average, the capsule longitudinal axis Z is tangent to curve s. The image planes have local coordinates φ and z, where z is parallel to Z. Each vertical line (in the z direction) in an image corresponds to a projection of a curve on the intestinal wall onto the Z axis. The line segments AD and BC illustrate two such projections.

The length of a projection is defined by:

$${L}_{proj} ( H ) = {\int }_{0}^{H} {m}_{z}^{- 1} ( φ , z ) d z$$

where H is the image height. For the case where there is no image distortion in the z direction, the magnification—with respect to the Z axis—is the ratio of conjugate distances v and u, which is represented by:

m_{z}(z,φ)=v/u(z,φ)

Thus, the length of the projection is proportional to an integration of the object conjugate distance u, which is defined by the following:

$${L}_{proj} = {\int }_{0}^{H} \frac{u ( φ , z )}{v} d z .$$

For an imaging system with distortion, the relationship between m_{z} and u is more complicated but still deterministic. If we assume that the imaging capsule trajectory is approximately along s, then we can estimate the position g along s for the nth stitched image as:

$$g ( n ) = {\sum }_{i = 1}^{n} {( {L}_{proj} ( {H}_{i} ) )}_{i} ,$$

where Hᵢ is the height of each constituent image that is preserved in the stitched image.

As can be appreciated by those skilled in the art, most panoramic images include a region where the imaging capsule is touching the—for example—intestinal mucosa. This region will be identifiable by a meniscus formed where the capsule contacts the moist mucosa. The object distance u and hence the magnification is known for objects touching the imaging capsule. By integrating m_{z}⁻¹ within these regions the position along the intestine can be determined. u may be derived in other ways as well, for example from a stereoscopic image. Alternatively, a 3D spatial model of the colon and the capsule within it may be derived from multiple overlapping images of colon. The capsule position is readily derived from this model.

Operationally, the imaging capsule will preferably begin image acquisition after a predetermined time has elapsed from the time that the capsule was swallowed. Once the capsule is retrieved, a user of the imaging workstation would identify the start of the colon—for example—visually (by identifying the ileo-cecal valve or other landmark), and then mark that location on the video display. Once the beginning is marked, then any subsequent location will be referenced from that marker by both time and distance. Accordingly, a reviewer would be able to determine the distance of the subsequent location from that (or other) markers.

Accordingly, the invention should be only limited by the scope of the claims attached hereto

What is claimed is:

1. An image review and navigation system comprising:
a workstation having a graphical computer interface that displays a panoramic image constructed from a plurality of in-vivo diagnostic images of an internal organ captured by an in-vivo imager;
CHARACTERIZED IN THAT
the panoramic in-vivo diagnostic image is a composite of a plurality of constituent images combined wherein more than one constituent-image subset contains a circumference about the organ's inner surface.

2. The imaging review and navigation system according to claim 1 wherein at least one of the constituent-image subsets comprises overlapping individual images.

3. The imaging review and navigation system according to claim 2 where the overlapping individual images form a panoramic image.

4. The imaging review and navigation system according to claim 1 wherein the constituent-image subset comprises a single image.

5. The imaging review and navigation system according to claim 4 where the image has a panoramic field of view.

6. The imaging review and navigation system according to claim 2 wherein each individual image comprising the subset is captured by a separate camera at substantially the same time.

7. The imaging review and navigation system according to claim 2 wherein each individual image comprising the subset is captured by the same camera at different times.

8. The imaging review and navigation system according to claim 1 wherein the composite panoramic image is one type selected from the group consisting of: rendered-3-D-spatial-model image; stitched “snakeskin” image.

9. The imaging review and navigation system according to claim 8 further comprising a rendering window for displaying the composite image wherein said rendering window includes one or more controls for rotating the image displayed therein.

10. The imaging review and navigation system according to claim 8 further comprising a rendering window for displaying the composite image wherein said rendering window includes one or more controls for annotating the image displayed therein.

11. The imaging review and navigation system according to claim 8 further comprising a rendering window for displaying the composite image wherein said rendering window includes one or more controls for designating markers upon the image displayed therein.

12. The imaging review and navigation system according to claim 11 wherein the designated markers indicate a current location and are automatically updated if the current location is updated in another window currently displayed within the system.

13. The imaging review and navigation system according to claim 11 wherein the designated markers indicate a current location and wherein moving one or more markers automatically updates the current location displayed in other windows currently displayed within the system.

14. The imaging review and navigation system according to claim 11 wherein the system displays the estimated distance between two object points within the organ designated by markers in the image.

15. The imaging review and navigation system according to claim 11 wherein the system displays the estimated distance along a curve on the surface of the organ designated by one or more markers on the image.

16. The imaging review and navigation system according to claim 11 wherein the system displays the estimated area of a region on the surface of the organ designated by one or more markers in the image.

17. The imaging review and navigation system according to claim 1 further comprising a status region for displaying a current working status of said images.

18. The imaging review and navigation system according to claim 1 further comprising a location region which displays the estimated in-vivo distance traveled by the imager, relative to a specified reference location, at the time that the selected image region was acquired by the imager.

19. A method of reviewing and navigating images captured of an internal organ by an in-vivo imager said method comprising the computer implemented steps of:
combining a plurality of constituent images wherein more than one constituent-image subset contains a circumference about the organ's inner surface; and
displaying the composite panoramic image on a computer workstation having a graphical computer interface.

20. The method according to claim 19 further comprising the steps of:
overlapping individual images to form the constituent-image subset.

21. The method according to claim 20 further comprising the steps of capturing each individual image comprising the subset by a separate camera at substantially the same time.

22. The method according to claim 20 further comprising the steps of capturing each individual image comprising the subset by the same camera at different times.

23. The method according to claim 20 where combining a plurality of constituent images comprises forming a 3-D spatial model based on the constituent images and rendering the spatial model.

24. The method according to claim 20 where combining a plurality of constituent images comprises stitching together overlapping constituent images and mapping the resulting image onto a 2-dimensional “snakeskin” image.

25. The method according to claim 19 wherein the composite panoramic image is one type selected from the group consisting of: rendered-3-D-spatial-model image; stitched “snakeskin” image.

26. The method according to claim 25 further comprising the steps of displaying the rendered 3-D image in a separate rendering image window.

27. The method according to claim 26 further comprising the steps of selectively rotating the rendered 3-D image.

28. The method according to claim 25 further comprising the steps of indicating a position or area of interest on the rendered 3-D image and updating all other windows displayed in the system to reflect the indicated position.

29. The method according to claim 25 further comprising the steps of updating an indicated location in one display window by moving a marker in another display window.

30. The method according to claim 25 further comprising the steps of updating an indicated location in one display window by advancing the frame in a displayed video stream from a frame showing one location to a frame showing the new location.

31. The imaging review and navigation system according to claim 8 further comprising a rendering window for displaying the composite image of an internal organ where each of two opposing edges of the composite image corresponds to a meridian on the internal organ.

32. The method according to claim 21 where the composite image is substantially rectangular.

33. The imaging review and navigation system according to claim 31 where the two meridians are substantially coincident.

34. The imaging review and navigation system according to claim 31 where the window includes a control for wrap-around scrolling wherein wrap-around scrolling comprises translating the image in a direction substantially perpendicular to the two opposing edges and where the image regions reappear in view at one edge at substantially the same time they disappear from view over the opposing edge.

35. The imaging review and navigation system according to claim 31 further comprising redundant overlap areas one positioned at each of the two opposing edges wherein a portion of image will appear in one of the overlap areas before it disappears from the other overlap area.

36. The method of claim 19 further comprising the display of a first segment of the composite image while a second segment is being generated with the computer-implemented combining of a plurality of constituent images.

37. In an imaging review and navigation system employing a computer implemented graphical user interface for displaying a diagnostic composite panoramic image, a method of estimating the distance between two object locations within said image comprising the steps of:
determining a location-dependent image magnification within the composite image displayed;
determining an integration of the inverse of the magnification along a curve between one object location and the other; and
producing the distance which results from the integration.

38. The method according to claim 37 further comprising the step of:
deriving the magnification from an estimate of the object distance.

39. The method according to claim 38 further comprising the step of:
estimating the distance by assuming that objects within a meniscus region identified in the image were touching an in-vivo diagnostic imaging capsule that captured the image at the time of capture.

40. The method according to claim 38 further comprising the step of:
estimating the object distance from a degree of overlap exhibited by two images captured by two cameras of known separation and relative orientation.

41. A method of estimating the distance between two points by extracting the information from the 3-D spatial model.

42. The imaging review and navigation system according to claim 8 further comprising a window displaying an anatomical drawing of an organ showing the estimated in-vivo imager location at which images displayed in the imaging window were captured.

43. The imaging review and navigation system according to claim 8 further comprising a video display window in which the constituent-image subsets are sequentially displayed in a time lapse stream in the order in which they were acquired by the in-vivo imager.

44. The imaging review and navigation system according to claim 43 wherein the location of the currently displayed constituent image subset is indicated in the composite image.

45. The imaging review and navigation system according to claim 11 further comprising a display window in which are displayed the constituent images that overlap with, in respect to scene imaged, the region of the composite image indicated by the marker.

46. In an imaging review and navigation system employing a computer implemented graphical user interface for displaying a diagnostic composite panoramic image of an internal organ, a method of annotating said image comprising the steps of:
designating a location within the composite image that corresponds to a location within the internal organ;
entering text; and
producing a data base that associates textual entries with the corresponding indicated locations within the internal organ.

47. The imaging review and navigation system of claim 46 where the a marker is used to make the designation.

48. The imaging review and navigation system of claim 46 where the selection of an image comprising one or more constituent images is used to make the designation.
